(19) United States
(12) Patent Application Publication
(10) Pub. No.: US 2025/0349925 A1
(43) Pub. Date: Nov. 13, 2025

(54) CHILLER OPERATION SYSTEM FOR ESS BATTERY AND METHOD OF OPERATING SAME

(71) Applicant: HanJungNCS.CO., LTD, Yeongcheon-si (KR)

(72) Inventors: Gi Bum PARK, Seongnam-si (KR); Hyung Kyun SHIN, Gyeongsan-si (KR); Hwan Sik KIM, Yeongcheon-si (KR); Hwan Seob KIM, Daegu (KR)

(21) Appl. No.: 19/188,130

(22) Filed: Apr. 24, 2025

(30) Foreign Application Priority Data
May 13, 2024 (KR) 10-2024-0062622

(51) Int. Cl. H01M 10/633; H01M 10/42; H01M 10/613

(52) U.S. Cl. CPC H01M 10/633; H01M 10/613; H01M 10/425; H01M 2010/4278

(57) ABSTRACT

Proposed are a chiller operation system for an ESS battery and a method of operating the same. The system includes an ESS battery, a battery control unit configured to control charging and discharging of the ESS battery, a chiller unit configured to cool the ESS battery according to a cooling control signal during the charging and discharging of the ESS battery, and a cooling control unit configured to perform heat management by providing the cooling control signal during the charging and discharging of the ESS battery. The cooling control unit is configured to communicate with the battery control unit to receive a cooling start signal, and provide the cooling control signal to the chiller unit when at least one of the cooling start signal or a preset chiller temperature condition is satisfied.

### CROSS REFERENCE TO RELATED APPLICATION

This application claims priority from and the benefit of Korean Patent Application No. 10-2024-0062622, filed on May 13, 2024, which is hereby incorporated by reference for all purposes as if fully set forth herein.

### BACKGROUND

### Field

Embodiments of the invention relate generally to a chiller operation system for an ESS battery and a method of operating the same, which performs heat management by providing a cooling control signal in a cooling control unit during charging and discharging of the ESS battery by mutually communicating with a battery control unit but provides the cooling control signal to a chiller unit when at least one of a cooling start signal input of the battery control unit and a preset chiller temperature condition is satisfied, thereby actively performing the heat management according to the charging and discharging environment of the ESS battery as well as improving the charging efficiency of the ESS battery.

### Discussion of the Background

As is well known, ESS (energy storage system) batteries that can be charged and discharged in eco-friendly vehicles, including electric vehicles and hybrid electric vehicles, require a system to manage the temperature of the ESS batteries in order to ensure optimal performance and efficiency by maintaining a target temperature (e.g., 20-30° C. for lithium-ion batteries) independent of the surrounding environment.

Such a system plays a role in delaying the temperature rise of the ESS battery when the battery modules arranged in a cell-like manner generate heat during charging and discharging of the ESS battery, which enables stable charging and discharging of the ESS battery.

However, a conventional system for managing the temperature of the ESS battery simply maintains the target temperature and does not manage the heat of the ESS battery through active cooling control according to the charging and discharging environment of the ESS battery, so it lacks the heat management of the ESS battery as well as it has a problem of reducing the ESS battery charging efficiency.

The above information disclosed in this Background section is only for understanding of the background of the inventive concepts, and, therefore, it may contain information that does not constitute prior art.

### SUMMARY

The present disclosure provides a chiller operation system for an ESS battery and a method of operating the same, the system and method performing heat management by providing a cooling control signal in a cooling control unit during charging and discharging of the ESS battery by mutually communicating with a battery control unit but providing the cooling control signal to a chiller unit when at least one of a cooling start signal input of the battery control unit and a preset chiller temperature condition is satisfied, thereby actively performing the heat management according to the charging and discharging environment of the ESS battery as well as improving the charging efficiency of the ESS battery.

An objective of exemplary embodiments of the present disclosure is not limited to the objective mentioned above, and other objectives not mentioned may be clearly understood by those skilled in the art to which the present disclosure belongs from the following description.

Additional features of the inventive concepts will be set forth in the description which follows, and in part will be apparent from the description, or may be learned by practice of the inventive concepts.

According to one aspect of the present disclosure, a chiller operation system for an ESS battery is provided, the system including an ESS battery, a battery control unit for controlling charging and discharging of the ESS battery, a chiller unit for cooling the ESS battery according to a cooling control signal during the charging and discharging of the ESS battery, and a cooling control unit for performing heat management by providing the cooling control signal during the charging and discharging of the ESS battery by mutually communicating with the battery control unit but for providing the cooling control signal to the chiller unit when at least one of a cooling start signal input of the battery control unit and a preset chiller temperature condition is satisfied.

In addition, according to one aspect of the present disclosure, a chiller operation system for an ESS battery is provided wherein the cooling control unit sets the chiller temperature condition using a chiller inlet temperature input to the chiller unit and a chiller outlet temperature outputted from the chiller unit.

In addition, according to one aspect of the present disclosure, a chiller operation system for an ESS battery is provided wherein the preset chiller temperature condition includes a first chiller temperature condition and a second chiller temperature condition that substantially exceeds the first chiller temperature condition.

In addition, according to one aspect of the present disclosure, a chiller operation system for an ESS battery is provided wherein the cooling control unit provides the cooling control signal to the chiller unit when both the first chiller temperature condition and the second chiller temperature condition are satisfied.

According to another aspect of the present disclosure, a method of operating a chiller operation system for an ESS battery is provided, the method including performing charging and discharging of an ESS battery according to a control of a battery control unit, checking whether a cooling start signal is input in a cooling control unit by mutually communicating with the battery control unit, providing a cooling control signal to a chiller unit from the cooling control unit when the cooling start signal is input, checking whether a preset chiller temperature condition is satisfied in the cooling control unit when the cooling start signal is not input, providing the cooling control signal to the chiller unit from the cooling control unit when the preset chiller temperature condition is satisfied, and performing heat management of the ESS battery in the chiller unit according to the cooling control signal.

According to another aspect of the present disclosure, a method of operating a chiller operation system for an ESS battery is provided, the method further including setting the chiller temperature condition using a chiller inlet temperature input to the chiller unit and a chiller outlet temperature outputted from the chiller unit before checking whether the preset chiller temperature condition is satisfied.

In addition, according to another aspect of the present disclosure, a method of operating a chiller operation system for an ESS battery is provided wherein the setting the chiller temperature condition is set to include a first chiller temperature condition and a second chiller temperature condition that substantially exceeds the first chiller temperature condition.

In addition, according to another aspect of the present disclosure, a method of operating a chiller operation system for an ESS battery is provided wherein the checking whether the preset chiller temperature condition is satisfied checks whether both the first chiller temperature condition and the second chiller temperature condition are satisfied.

The present disclosure performs heat management by providing a cooling control signal in a cooling control unit during charging and discharging of the ESS battery by mutually communicating with a battery control unit but provides the cooling control signal to a chiller unit when at least one of a cooling start signal input of the battery control unit and a preset chiller temperature condition is satisfied, thereby actively performing the heat management according to the charging and discharging environment of the ESS battery as well as improving the charging efficiency of the ESS battery.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram of a chiller operation system for an ESS battery according to an exemplary embodiment of the present disclosure,

FIG. 2 is a flowchart showing a process of operating a chiller operation system for an ESS battery according to another exemplary embodiment of the present disclosure,

FIG. 3 is a flowchart showing an operating process according to a first chiller temperature condition and a second chiller temperature condition according to another exemplary embodiment of the present disclosure, and

FIG. 4 is a view for illustrating a process of operating a chiller operation system for an ESS battery according to another exemplary embodiment of the present disclosure.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes.

When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on.” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, Y Z, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 9 0degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Advantages and features of exemplary embodiments of the present disclosure and methods for achieving them will become clear with reference to the exemplary embodiments described below in detail together with the accompanying drawings. However, the present disclosure is not limited to the exemplary embodiments disclosed below and may be implemented in various forms different from each other, and the present exemplary embodiments are provided only to make the disclosure of the present disclosure complete and to fully inform those skilled in the art to which the present disclosure belongs of the scope of the present disclosure, and the present disclosure is only defined by the scope of the claims. Throughout the present specification, the same reference numerals refer to the same components.

In describing the exemplary embodiments of the present disclosure, the detailed description thereof will be omitted, when it is determined that a detailed description of a known function or configuration may unnecessarily obscure the gist of the present disclosure. The terms to be described below are terms defined in consideration of the function in the exemplary embodiment of the present disclosure, and may vary depending on the intent or custom of a user or an operator. Therefore, the definitions should be based on the content throughout the present specification.

Hereinafter, the exemplary embodiments of the present disclosure will be described in detail with reference to the accompanying drawings.

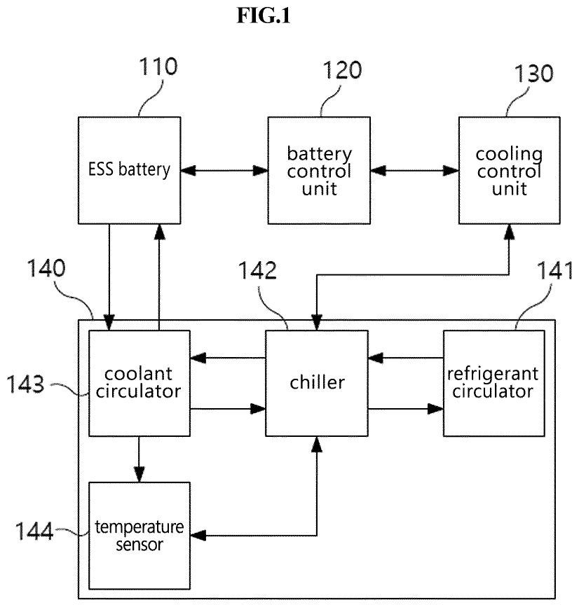

FIG. 1 is a block diagram of a chiller operation system for an ESS battery according to an exemplary embodiment of the present disclosure.

Referring to FIG. 1, the chiller operation system for an ESS battery according to an exemplary embodiment of the present disclosure may include an ESS battery 110, a battery control unit 120, a cooling control unit 130, a chiller unit 140, and the like.

The ESS battery 110 may include a battery module composed of battery cells, including, for example, lithium-ion batteries, and can be charged or discharged under the control of the battery control unit 120.

The battery control unit 120 may be a unit for controlling the charging and discharging of the ESS battery 110, including a battery control unit (B CU) for controlling the entire ESS battery 110, a battery control panel (BCP) for controlling the inside of the ESS battery 110, and the like, and may mutually communicate with the cooling control unit 130 and control the charging and discharging of the ESS battery 110.

Such a battery control unit 120 may provide a cooling start signal to the cooling control unit 130 in order to cool the ESS battery 110 through the chiller unit 140 during the charging and discharging of the ESS battery 110.

The cooling control unit 130 may perform heat management by providing the cooling control signal during the charging and discharging of the ESS battery 110 by mutually communicating with the battery control unit 120, but may provide the cooling control signal to the chiller unit 140 when at least one of the cooling start signal input of the battery control unit 120 and a preset chiller temperature condition is satisfied.

Such a cooling control unit 130 may set a chiller temperature condition using a chiller inlet temperature input to the chiller unit 140 and a chiller outlet temperature outputted from the chiller unit 140, and the preset chiller temperature condition may include a first chiller temperature condition and a second chiller temperature condition that substantially exceeds the first chiller temperature condition.

For example, through the battery control unit 120, the cooling control unit 130 may check whether the cooling start signal is input by mutually communicating with the battery control unit 120 during the charging and discharging of the ESS battery 110 and may provide the cooling control signal to the chiller unit 140 when the cooling start signal is input.

Also, the cooling control unit 130 may check whether the preset chiller temperature condition is satisfied when the cooling start signal is not input from the battery control unit 120, and may provide the cooling control signal to the chiller unit 140 when the preset chiller temperature condition is satisfied.

Herein, in the process of checking whether the preset chiller temperature condition is satisfied, the cooling control unit 130 may provide the cooling control signal to the chiller unit 140 when both a first chiller temperature condition and a second chiller temperature condition are satisfied.

For example, the cooling control unit 130 may set a cooling mode elapsed time (N) to an initial value (0), may receive from the chiller unit 140 the chiller outlet temperature (T1) and the chiller inlet temperature (T2) obtained through a temperature sensor 144 provided in the chiller unit 140, and may check (T2-T1>SV.temp#1) whether a difference value (T2-T1) between the chiller inlet temperature (T2) and the chiller outlet temperature (T1) exceeds a preset first chiller temperature value (SV.temp#1, for example, 1).

Also, the cooling control unit 130 may return to the setting the cooling mode elapsed time (N) to an initial value (0) when the difference value (T2-T1) between the chiller inlet temperature (T2) and the chiller outlet temperature (T1) is less than or equal to the preset first chiller temperature value (SV.temp#1) and may set the cooling mode elapsed time (N) cumulatively (N=N+1) by adding a preset additional value (1) when the difference value (T2-T1) between the chiller inlet temperature (T2) and the chiller outlet temperature (T1) exceeds the preset first chiller temperature value (SV.temp#1).

In addition, the cooling control unit 130 may check whether the difference value (T2-T1) between the chiller inlet temperature (T2) and the chiller outlet temperature (T1) is greater than or equal to a preset second chiller temperature value (SV.temp#2, for example, 2), and may provide the cooling control signal for starting the chiller unit 140 when the difference value (T2-T1) between the chiller inlet temperature (T2) and the chiller outlet temperature (T1) is greater than or equal to the preset second chiller temperature value (SV.temp#2).

Meanwhile, the cooling control unit 130 may check whether an accumulatively set cooling mode elapsed time (N) is less than or equal to a preset start observation time (SV.Time#1) when the difference value (T2-T1) between the chiller inlet temperature (T2) and the chiller outlet temperature (T1) is less than the preset second chiller temperature value (SV.temp#2), and may return to the receiving the chiller outlet temperature (T1) and the chiller inlet temperature (T2) from the chiller unit 140 when the accumulatively set cooling mode elapsed time (N) is less than or equal to the preset start observation time (SV.Time#1), and provide the cooling control signal for starting the chiller unit 140 when the accumulatively set cooling mode elapsed time (N) exceeds the preset start observation time (SV.Time#1).

The chiller unit 140 may be a unit for cooling the ESS battery 110 according to the cooling control signal provided from the cooling control unit 130 during the charging and discharging of the ESS battery 110, and may include a refrigerant circulator 141, a chiller 142, a coolant circulator 143, a temperature sensor 144, and the like.

Herein, the refrigerant circulator 141 may include a compressor, condenser, expander, evaporator, or the like, and may circulate refrigerant through the interior of the chiller 142.

Also, the chiller 142 may control to circulate the coolant at a preset temperature to the ESS battery 110 by exchanging heat between the refrigerant circulated by the refrigerant circulator 141 and the coolant circulated by the coolant circulator 143.

In addition, the coolant circulator 143 may allow the coolant circulated through the interior of the chiller 142 to exchange heat with the refrigerant circulated through the refrigerant circulator 141 and the coolant may be circulated through the interior of the metal plate provided in the lower part of each battery module provided in the ESS battery 110 and the interior of the chiller 142.

The temperature of each battery module provided in the ESS battery 110 can be maintained at the target temperature through the coolant circulated through the internal flow paths of these metal plates.

Meanwhile, the temperature sensor 144 may be provided on a coolant circulation line inside the chiller 142, and may measure the chiller outlet temperature (T1) outputted to the metal plate through the coolant circulator 143 from the interior of the chiller 142 and the chiller inlet temperature (T2) input to the interior of the chiller 142 through the coolant circulator 143 circulating the metal plate and provide the same to the cooling control unit 130.

Therefore, an exemplary embodiment of the present disclosure performs heat management by providing a cooling control signal in a cooling control unit during charging and discharging of the ESS battery by mutually communicating with a battery control unit but provides the cooling control signal to a chiller unit when at least one of a cooling start signal input of the battery control unit and a preset chiller temperature condition is satisfied, thereby actively performing the heat management according to the charging and discharging environment of the ESS battery as well as improving the charging efficiency of the ESS battery.

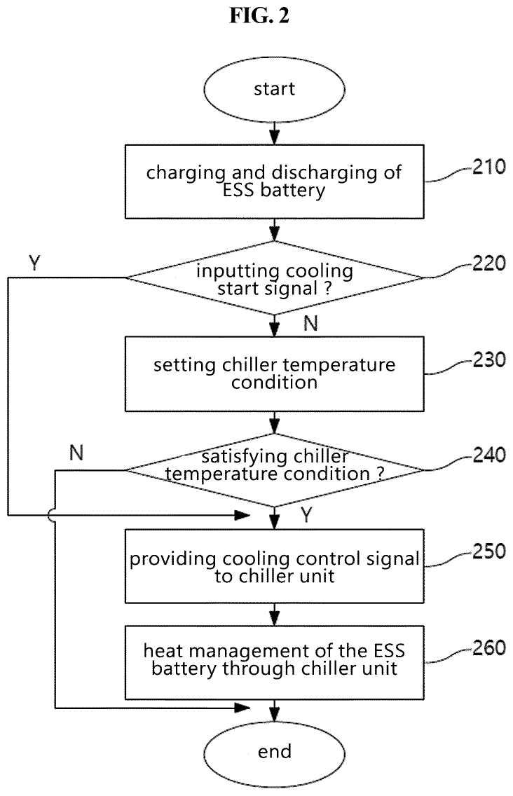

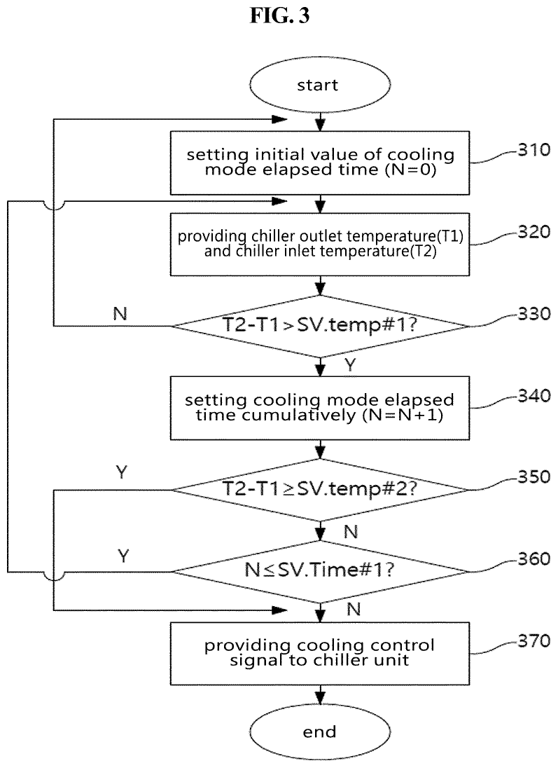

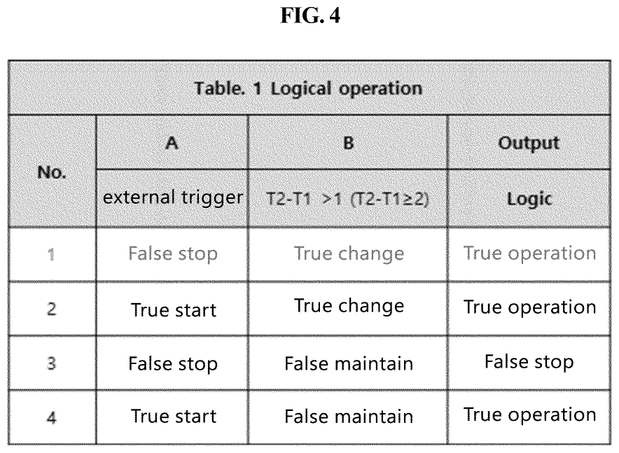

FIG. 2 is a flowchart showing a process of operating a chiller operation system for an ESS battery according to another exemplary embodiment of the present disclosure, FIG. 3 is a flowchart showing an operating process according to a first chiller temperature condition and a second chiller temperature condition according to another exemplary embodiment of the present disclosure, and FIG. 4 is a view for illustrating a process of operating a chiller operation system for an ESS battery according to another exemplary embodiment of the present disclosure.

Referring to FIGS. 2 to 4, the charging and discharging of the ESS battery 110 may be performed under the control of the battery control unit 120 (step 210).

Also, the cooling control unit 130 may check whether a cooling start signal is input by mutually communicating with the battery control unit 120 (step 220).

When the cooling start signal is input as a result of the check in the step 220, the cooling control unit 130 may provide the cooling control signal to the chiller unit 140 (step 250).

Meanwhile, the cooling control unit 130 may set the chiller temperature condition using the chiller inlet temperature (T2) input to the chiller unit 140 and the chiller outlet temperature (T1) outputted from the chiller unit 140 (step 230).

The (230) setting the chiller temperature condition may be set to include a first chiller temperature condition and a second chiller temperature condition that substantially exceeds the first chiller temperature condition.

The (230) setting the chiller temperature condition as described above may be shown and described as being performed after the (220) checking whether the cooling start signal is input, but this is only for convenience of explanation, and it may be performed at any step as long as it is performed before the (240) checking whether the preset chiller temperature condition to be described later is satisfied.

Meanwhile, when the cooling start signal is not input as a result of the check in the step 220, the cooling control unit 130 may check whether the preset chiller temperature condition is satisfied (step 240).

Such the (240) checking whether the preset chiller temperature condition is satisfied may check whether both the first chiller temperature condition and the second chiller temperature condition are satisfied.

When the preset chiller temperature condition is satisfied as a result of the check in the step 240, the cooling control unit 130 may provide the cooling control signal to the chiller unit 140 (step 250).

Next, the chiller unit 140 may perform the heat management of the ESS battery (i.e., coolant circulation, etc.) according to the cooling control signal from the cooling control unit 130 (step 260).

Referring to FIG. 3 for a more detailed description of the (250) checking whether the preset chiller temperature condition is satisfied and the (260) providing the cooling control signal as described above, the cooling mode elapsed time (N) may be set to the initial value (0) in the cooling control unit 130, (step 310).

Also, the cooling control unit 130 may receive from the chiller unit 140 the chiller outlet temperature (T1) and the chiller inlet temperature (T2) obtained through the temperature sensor 144 provided in the chiller unit 140 (step 320).

Next, the cooling control unit 130 may check (T2-T1>SV.temp#1) whether the difference value (T2-T1) between the chiller inlet temperature (T2) and the chiller outlet temperature (T1) exceeds the preset first chiller temperature value (SV.temp#1, for example, 1) (step 330).

As a result of the check in the step 330, when the difference value (T2-T1) between the chiller inlet temperature (T2) and the chiller outlet temperature (T1) is less than or equal to the preset first chiller temperature value (SV.temp#1), the cooling control unit 130 may return to the (310) setting the cooling mode elapsed time (N) to the initial value (0).

Meanwhile, as a result of the check in the step 330, when the difference value (T2-T1) between the chiller inlet temperature (T2) and the chiller outlet temperature (T1) exceeds the preset first chiller temperature value (SV.temp#1), the cooling control unit 130 may set the cooling mode elapsed time (N) cumulatively (N=N+1) by adding the preset additional value (1) (step 340).

Next, the cooling control unit 130 may check (T2-T1>SV.temp#2) whether the difference value (T2-T1) between the chiller inlet temperature (T2) and the chiller outlet temperature (T1) is greater than or equal to a preset second chiller temperature value (SV.temp#2, for example, 2) (step 350).

When the difference value (T2-T1) between the chiller inlet temperature (T2) and the chiller outlet temperature (T1) is greater than or equal to the preset second chiller temperature value (SV.temp#2) as a result of the check in the step 350, the cooling control signal may be provided for starting the chiller unit 140 (step 370).

Meanwhile, when the difference value (T2-T1) between the chiller inlet temperature (T2) and the chiller outlet temperature (T1) is less than the preset second chiller temperature value (SV.temp#2) as a result of the check in the step 350, the cooling control unit 130 may check (N≤SV.Time#1) whether the accumulatively preset cooling mode elapsed time (N) is less than or equal to a preset start observation time (SV.Time#1) (step 360).

When the accumulatively preset cooling mode elapsed time (N) is less than or equal to the preset start observation time (SV.Time#1) as a result of the check in the step 360, the cooling control unit 130 may return to the (320) receiving the chiller outlet temperature (T1) and the chiller inlet temperature (T2) from the chiller unit 140.

Meanwhile, when the accumulatively preset cooling mode elapsed time (N) exceeds the preset start observation time (SV.Time#1) as a result of the check in the step 360, the cooling control unit 130 may provide the cooling control signal for starting the chiller unit 140 (step 370).

In another exemplary embodiment of the present disclosure as described above, there are four cases in the mode where the cooling control unit 130 starts the chiller unit 140 as shown in FIG. 4, and the state A may refer to a case where the battery controller unit 120 provides the cooling start signal (i.e., an external trigger) to the cooling control unit 130, and the state B may refer to a case where the preset chiller temperature condition is satisfied in the cooling control unit 130.

Herein, the case of No. 1 may refer to a case where the state of A is False (stop) and the state of B is True (change), and the cooling control unit 130 may determine this case as True (operation) and provide the cooling control signal for starting the chiller unit 140. Surely, in the case where the state of A is False (stop) and the state of B is True (change), the chiller unit 140 can be stopped (not started) by determining as False (stop).

Also, the case of No. 2 may refer to a case where the state of A is True (start) and the state of B is True (change) and the cooling control unit 130 may determine this case as True (operation) and provide the cooling control signal for starting the chiller unit 140.

In addition, the case of No. 3 may refer to a case where the state of A is False (stop) and the state of B is False (maintain) and the cooling control unit 130 may determine this case as False (stop) and stop (not start) the chiller unit 140.

In addition, the case of No. 4 may refer to a case where the state of A is True (start) and the state of B is False (maintain), and the cooling control unit 130 may determine this case as True (operation) and provide the cooling control signal for starting the chiller unit 140.

That is, the chiller unit 140 can be started when only one of the A state and the B state is True.

Therefore, an exemplary embodiment of the present disclosure performs heat management by providing a cooling control signal in a cooling control unit during charging and discharging of the ESS battery by mutually communicating with a battery control unit but provides the cooling control signal to a chiller unit when at least one of a cooling start signal input of the battery control unit and a preset chiller temperature condition is satisfied, thereby actively performing the heat management according to the charging and discharging environment of the ESS battery as well as improving the charging efficiency of the ESS battery.

In the description above, various exemplary embodiments of the present disclosure have been presented and described, but the present disclosure is not necessarily limited thereto, and it will be easily understood by those skilled in the art to which the present disclosure pertains that various substitutions, modifications, and changes may be possible within the scope not departing from the technical idea of the present disclosure.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A chiller operation system for an energy storage system (ESS) battery, the system comprising:
an ESS battery;
a battery control unit configured to control charging and discharging of the ESS battery;
a chiller unit configured to cool the ESS battery according to a cooling control signal during the charging and discharging of the ESS battery; and
a cooling control unit configured to perform heat management by providing the cooling control signal during the charging and discharging of the ESS battery,
wherein the cooling control unit is configured to:
communicate with the battery control unit to receive a cooling start signal, and
provide the cooling control signal to the chiller unit when at least one of the cooling start signal or a preset chiller temperature condition is satisfied.

2. The system of claim 1, wherein the cooling control unit is configured to set the chiller temperature condition using a chiller inlet temperature input to the chiller unit and a chiller outlet temperature outputted from the chiller unit.

3. The system of claim 2, wherein the preset chiller temperature condition comprises a first chiller temperature condition and a second chiller temperature condition that substantially exceeds the first chiller temperature condition.

4. The system of claim 3, wherein the cooling control unit is configured to provide the cooling control signal to the chiller unit when both the first chiller temperature condition and the second chiller temperature condition are satisfied.

5. A method of operating a chiller operation system for an energy storage system (ESS) battery, the method comprising the steps of:
performing charging and discharging of an ESS battery according to a control of a battery control unit;
checking whether a cooling start signal is input in a cooling control unit by mutually communicating with the battery control unit;
providing a cooling control signal to a chiller unit from the cooling control unit when the cooling start signal is input;
checking whether a preset chiller temperature condition is satisfied in the cooling control unit when the cooling start signal is not input;
providing the cooling control signal to the chiller unit from the cooling control unit when the preset chiller temperature condition is satisfied; and
performing heat management of the ESS battery in the chiller unit according to the cooling control signal.

6. The method of claim 5, further comprising a step of:
setting the chiller temperature condition using a chiller inlet temperature input to the chiller unit and a chiller outlet temperature outputted from the chiller unit before checking whether the preset chiller temperature condition is satisfied.

7. The method of claim 6, wherein the step of setting the chiller temperature condition comprises a step of setting a first chiller temperature condition and a second chiller temperature condition that substantially exceeds the first chiller temperature condition.

8. The method of claim 7, wherein the step of checking whether the preset chiller temperature condition is satisfied comprises a step of checking whether both the first chiller temperature condition and the second chiller temperature condition are satisfied.
